(19) United States
(12) Patent Application Publication
(10) Pub. No.: US 2021/0395642 A1
(43) Pub. Date: Dec. 23, 2021

(54) METHOD AND SYSTEM OF MAKING DECORATIVE CANDLES

(71) Applicant: UAB FLATYZ, Kauas (LT)

(72) Inventor: Aidutis Gilaitis, Vilkaviskis (LT)

(21) Appl. No.: 17/351,262

(22) Filed: Jun. 18, 2021

(30) Foreign Application Priority Data
Jun. 19, 2020 (LT) LT2020529

(51) Int. Cl. C11C 5/02; C11C 5/00

(52) U.S. Cl. CPC C11C 5/028; C11C 5/006; C11C 5/008

(57) ABSTRACT

The present invention relates to candles, manufacturing and decorating thereof. It is a method and system to produce decorative candles of unique shapes, by using special raw material preparation and candle shaping by hand and, if necessary, with simple sculptural tools. The candle is made without melting the raw material mass to a liquid consistency and without using complex solid raw material forming equipment. Unlike the known methods, in the present invention, during the candle production period (11, 12, 13), the plastic state of the raw material (similar to the consistency of plasticine, sculptural clay or gypsum) is maintained on a regular basis and, in this state, various decorative candle shapes can be formed even by hand only. This method makes it possible to design and make various forms of decorative candles at low cost and provides people with inexpensive means of making candles (such as manufacturing kits) that allow them to unleash their creativity in the production of decorative candles. Also, this method is useful for creating prototypes of decorative candles, from which the corresponding molds for casting or pressing candles are subsequently prepared and the candles are mass-produced by casting or pressing those molds.

### BACKGROUND OF THE INVENTION

### Field of the Invention

The present invention relates to candles, including making and decorating thereof. In particular, it is a method and system for designing and making uniquely shaped decorative candles, where the raw material of the candle is prepared in a special way, and a candle can be formed by hand and simple tools.

### Description of Related Art

In the field of decorative candle production, several main production methods are known. It is often common to cast a candle from a liquid raw material (wax, paraffin, or stearin) in the predetermined mold of a decorative candle. Another way is to press the candle from a granular raw material. Still other techniques involve decorating the surface of the candles with paint, with embossing, and with patterns.

The raw material for candles is derived from the vegetable or animal fats, or paraffin from the refining of oil. Beeswax, palm wax, paraffin, stearin, mixtures thereof or other known substances are supplied to candle manufacturers in solid forms (blocks, chips, granules or powder) or already melted (liquid). In the process zo of candle production, the solid raw material is pressed with the help of technological equipment and acquires the intended shape, or melted to a liquid consistency and, while in a liquid state, is poured into molds or soaked. Depending on the desired color of the candle, the liquid mass of the raw material can be painted and/or scented.

Candles can be made in various shapes and sizes by filling the raw material into prepared molds. Cylindrical candles are formed by pressing or soaking. Decorative figurine candles that replicate animals, flowers, leaves, trees, or other naturally occurring or imagined elements are made by casting in molds. Candles can come in a variety of colors and scents. In the production by the above-mentioned methods, the raw material is either liquid or solid. Before casting the candle, the raw material must be melted, and then hot liquid raw material is used. Forming a candle from a solid raw material requires a complex technological device (press). After casting or pressing, the surface of the candles can be decorated: painted, decorated by drawing, screen printing, printing, engraving, gluing, cutting, or embossing. The candle wick can be inserted before casting the candle or after casting when it has already hardened.

Patent application WO2005116176 (U.S. Pat. No. 8,840,399B2) describes a method and means for producing decorative candles of various shapes. The shapes of the manufactured candles can be from simple to decorative, ornamented, three-dimensional objects made of wax plates, profiles, and shapes, with a separately inserted wick, such as straight, curved or branched, as well as a new device for producing decorative wax plates as semi-finished products suitable for use in the said method of candle production. This method and means are quite complex, involving many molds for candle casting, pouring liquid raw material, and grinding of hardened material. Creativity is limited by the molds and kit of production tools provided.

Japanese patent application JP2015113470 describes a method for making a flower-shaped candle consisting of a flower core and a plurality of petals. The wax is heated until it melts, and the spoonful of wax is spread in a thin layer on a flat surface to form many wax sheets in a plastic state. The first wax sheet is folded, rounded and made into a spherical element with a pattern carved with a bamboo pin, and the second wax sheet is cut with a pin so as to form a bowl-like element with an uneven outer edge and a concave central portion. The core of the flower consists of a spherical and bowl-shaped element placed into one another. Each flower petal is made from a third sheet of wax having approximately circular shape. The flower consists of petals arranged with a displacement around the flower core to wrap the flower core from below and to reveal at least the upper surface of the flower core. This method describes the production of one particular shaped candle and uses a liquid wax from which the leaves are cast, and the elements of the flower core are cut.

Patent application WO2019214790 describes a way to decorate candles by heating the manufactured candle to a temperature at which it softens but does not yet melt. After that, the candle and the paint decoration are pressed against each other and moved (the decoration is slided and the candle is rolled) relative to each other. During decoration, part of the material on the surface of the candle is plastically deformed, stretched, or embossed but remains part of the candle. The method describes decorating the surface of the candle with embossing and paint. The main shape of the candle does not change substantially, and deformations are obtained on the surface of the candle as decorative embossing or patterns.

Lithuanian patent LT5467B describes the production of a candle/postcard. The candle/postcard composition includes three components: a flat candle, a prefabricated candlestick stand, and a paper package. The components are designed so that the candle with the stand can be packed in a paper package. The stand is assembled from the U-profile upper part of the stand (the holder) and the lower part of the stand (the pad). These two parts are connected to each other using specially designed connection units. The flat candle/postcard can be decorated with various drawings, painted with a brush or other means. However, only the flat surface of the candle/postcard is decorated with paint here, and the shape of the candle itself is not changed.

U.S. patent US2016178156 (U.S. Pat. No. 9,841,160B2) describes a decorative candle housing made of a flat flexible translucent decorated plastic or paper sheet. The opposite edges of the sheet are provided with stapling means (notches) by means of which the flexible sheet is stapled with opposite edges when folded around the candle. In this way, the candle is surrounded with a decorated translucent housing. An unused sheet can be stored unstapled in a flat state. In the described patent, the shape of the decoration is essentially a cylinder with painted drawings illuminated from inside of the cylinder by the flame of the burning candle, but the shape of the candle itself is invisible and does not provide an aesthetic effect.

Another U.S. Pat. No. 6,406,290B1 describes a similar method of decoration in which a sheet of paper decorated with drawings is adhered to the surface of a candle (wrapped around a candle) and, when heated from outside, the candle material softens or begins to melt and adheres to this decorated paper. After the candle cools, the decorated paper sticks to the surface of the candle. As in the case of U.S. Pat. No. 9,841,160B2, the form of the decoration is a paper cylinder with drawings illuminated by the candle flame from inside the cylinder.

U.S. patent US2016244696 (U.S. Pat. No. 10,184,093B2) describes the production of decorative candles when a candle is cast from a liquid wax in the form of a cylinder, the inner walls of which are decorated with paint before casting, and when the candle is casted, these paints become decorations on the surface of the candle. This method uses casting from a liquid raw material, the shape of the candle is cylindrical or close to it, and the resulting decoration is the painting of the surface of the candle cylinder.

U.S. Pat. No. 6,241,512B1 describes a method of decorating candles in which the main wax candle is placed in a transparent container and filled with a transparent mixture having a melting point higher than said wax and containing elements with a gelatinous structure. When the main candle burns out, a cavity remains in the container and in the mixture with the gelatin elements in which a new wax candle can be placed. This method also uses casting from a liquid raw material, the shape of the candle being cylindrical or close to it, and the decoration zo is obtained by the light of the burning wax candle inside propagating through the solidified transparent mixture of colored gelatin elements and the walls of the glass container.

The described inventions and methods of candle production are characterized by relatively complex (for individual manufacturer) production equipment, limited spatial forms of decorative candles, or are intended for mass production of candles of standardized shape (casting, pressing, stamping). Such means of production are expensive and require skilled operation. Known hand-held candle-making tools use certain raw material blanks, as well as production methods that rely only on liquid raw material casting and soaking, and solid raw material pressing and processing with special tools, thus providing limited opportunities for candle decoration and creation of unique shapes. A more creative, but at the same time an easier way to shape and make candles is made possible by the candle-making kit for children “SES Creative Crafts kit for Kids|Easy Candles out of Wax Clay for Kids”. In this kit it is possible to sculpt candles of various shapes and colors from a special soft wax mass of various colors, similar to plasticine, and such candles then can be ignited. Also, a similar soft wax candle is described in another U.S. patent application. US20110014579.

However, these inventions, kits, candle raw materials, and the use of manufactured candles based on the use of a special soft raw material only have extremely limited application, characteristics and are suitable for the production of only small toy candles, usually in the course of a game.

### SUMMARY OF THE INVENTION

In order to avoid the complex casting, pressing, and decorating technologies used in known candle production methods, and to enable creatively and safely (as well as at home) make individual industrial decorative candles of unique shapes, the present invention describes a suitable production method and a system of means.

Purpose of the invention: to provide a method for designing or making a candle without melting the raw material mass to a liquid consistency and without using complex equipment. It provides an opportunity to make decorative candles of various shapes at a lower cost. Wide range of people shall have new inexpensive means of production, which shall allow people's creativity in the production of decorative candles to unfold. This method of production makes it possible not only to decorate the candle by plastic deformation of the surface of the candle itself (for example, as in patent application WO2019214790), but also—by drawing, pressing, bending, twisting, cutting, or using a combination of all these techniques—to substantially change the decorative shape and an aesthetic look of the candle. Also, by changing their shape from semi-finished products, combining semi-finished products with each other, and joining them together, embossing or otherwise gluing together—to make candles of various shapes or other semi-finished products required to produce a candle (candle-flower, candle-pot). This method of production does not involve remelting the raw material into liquid or pressing the solid raw material. In contrast, in this case, the plastic state of the raw material (plasticine, sculptural clay or gypsum consistency) is maintained during the candle production period, and with the raw material in this state, any decorative shape of the candle can be produced even by hand. Various tools can be used as needed. Such production method, system of means and materials can be placed on the market to the general public as an inexpensive and convenient product—a candle production kit. Also, this making method is convenient for creating and modeling prototypes of decorative candles, which are then used to prepare appropriate molds for candle casting or pressing and to produce candles by mass casting or pressing.

### BRIEF DESCRIPTION OF DRAWINGS

Attached diagrams and drawings make an integral part of the description of the invention and are provided as a reference to a possible embodiment of the invention but are not intended to limit the scope of the invention. The drawings and diagrams do not necessarily correspond to the scale of the components of the invention. Components that are not necessary to explain the operation of the invention and have no relation are not provided.

FIG. 1 The method of candle production and its steps;

FIG. 2a-e Candles of the unique shape produced by the production method disclosed in the present invention:

(a) The raw candle blanks from which candles can be formed;

(b) The unique candles made by the method of the present invention;

(c) The production example: a blank of raw material and a candle in its unique shape sculpted by hand;

(d) The hand-made candle in its unique shape with additionally painted edges;

(e) The flower-shaped candle formed from several blanks of a different color by the method of the present invention.

FIG. 3a-c The preheating device designed to create and maintain the plastic consistency of the raw material, suitable for forming candles by means of a plastic sculpturing:

(a) The preheating device with a chamber in which the raw material is heated by air-blowing the blank with a stream of heated air;

(b) The flat heating pad, tabletop, or flexible table cover on top of which the raw material plates are placed and preheated;

(c) The device for preheating the raw material blank by infrared radiation.

FIG. 4a-b The uniquely-shaped (e.g., flower-shaped) candle formed by the method of the present invention inside a glass container with an upper opening that is too narrow to simply place a prefabricated candle in this glass container:

(a) side view of the candle;

(b) top view of the candle.

FIG. 5 The candle formed in a container-shaped candlestick made by the method of the present invention, and in the second step by applying a candle-flower shape to the candlestick created in the first step.

FIG. 6a-c Decorative bowl-shaped candlestick as a candle container (which will be further formed inside this candlestick-bowl):

(a) circular initial raw material blank;

(b) the embossing on the circular blank by a plastic deformation tool;

(c) the hand-made decorative bowl-shaped candlestick.

### DRAWINGS—DESCRIPTION OF HIGHLIGHTED ITEMS

1 The device for maintaining the plastic consistency of the raw material heating and the candle blank;
2 The candle blank (also, candle raw material, candle raw material blank), i.e., plates, cubes, balls, or prepared candle semi-finished products of various shapes);
3 The preheating unit compartment (shelf) for housing the heated raw material blank;
4 The heating timer;
5 The heating temperature controller;
6 The on/off button/knob;
7 The heating element;
8 The fan (heated-air-stream blower);
9 The candle raw plastic sculpting tools (can be used optionally, as needed);
10 The production method step: presentation of candle raw material (stearin, paraffin, wax) with blanks of various shapes, colors, and scents;
11 The production method step: initial preheating of the raw material blank to produce the raw material of plastic consistency;
12 The production method step: re-preheating the raw material blank to maintain the plastic consistency of the candle blank;
13 The production method step: shaping the candle blank by hand. Additional sculpting tools (9) can be used optionally;
14 The production method step: cooling of the formed candle and transition of its material from the plastic state to the solid state;
15 The raw material blank temperature and status sensor / transducer in the heating device (1);
16 The candle blank that differs from the raw blank (2) in that it is a candle that has already been formed and is not yet finished;
17 The shaped candle.

### DETAILED DESCRIPTION OF THE INVENTION

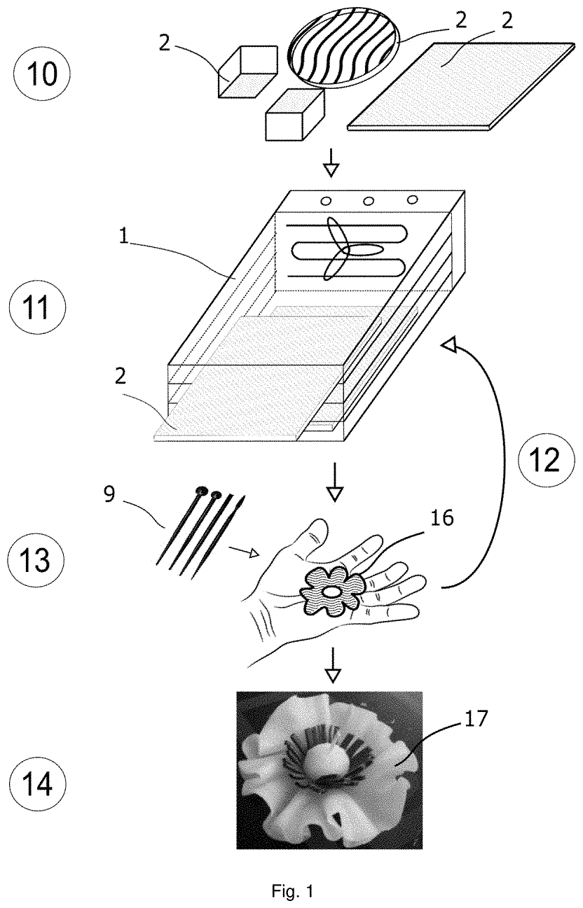

This section describes the method of candle production (FIG. 1) and a system of means of production for producing candles by this method.

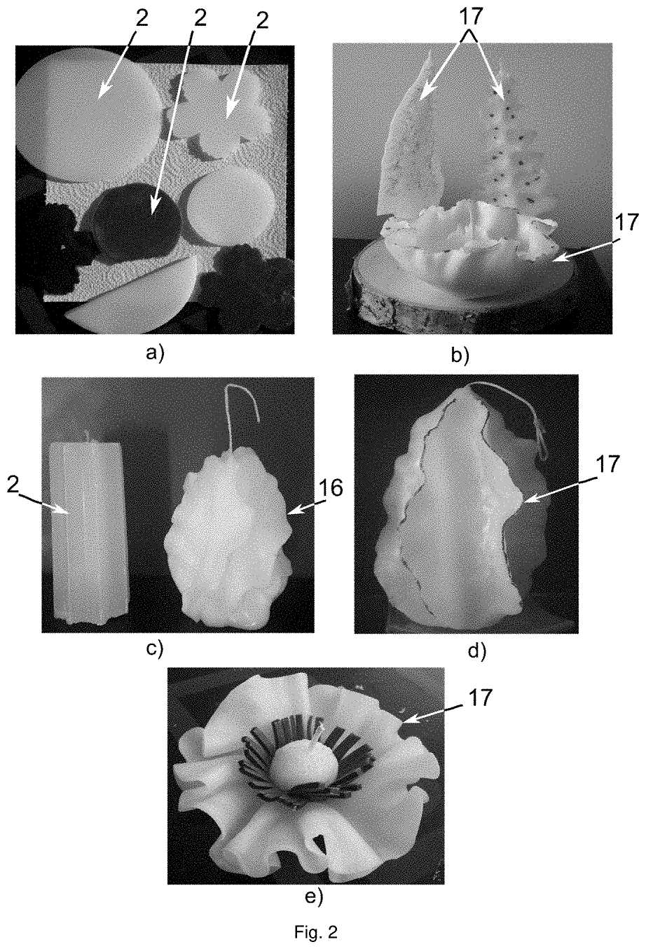

The method of candle production. The method of candle production and its steps are shown in FIG. 1. According to this method of production, the raw material may be available in the form of a ready-made candle of the usual shape (table candle, cylindrical, star, hexagonal, triangular, or other available on the market candle), or preferably raw material is prepared in the form of plates. Raw material plates can be of various thicknesses (the most convenient range of plate thicknesses is from 0.1 millimeters to 10 millimeters), in various geometric shapes, or in strips, depending on the desired result. Various other shapes of raw material blanks can be used—ball, cube, roll, cone—only these shapes can be slightly less convenient to use, as it takes longer to heat the workpiece until the entire volume of the raw material blank reaches the same plastic consistency. Some practical examples of raw material blanks are shown in FIG. 2a. Candle blanks can come in a variety of colors and scents.

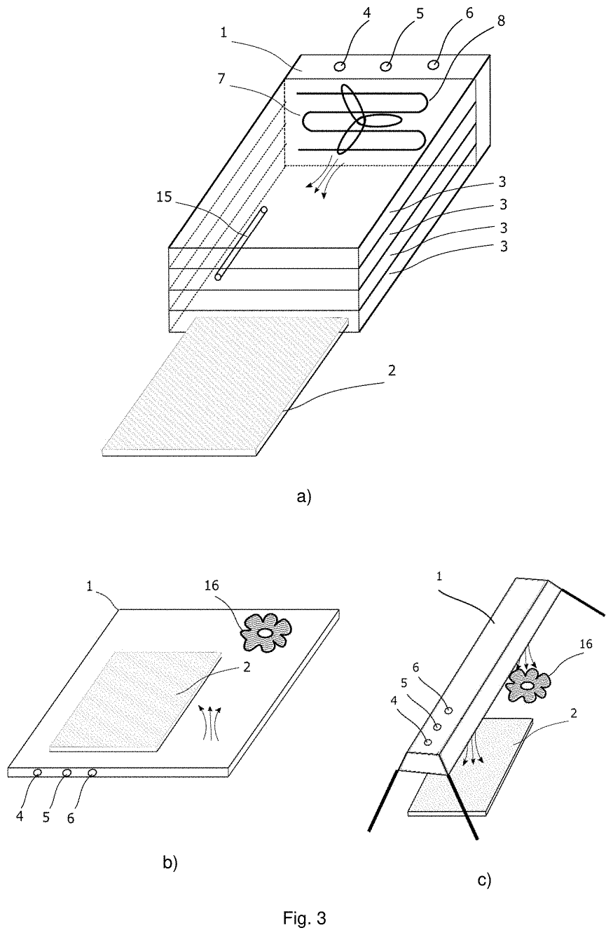

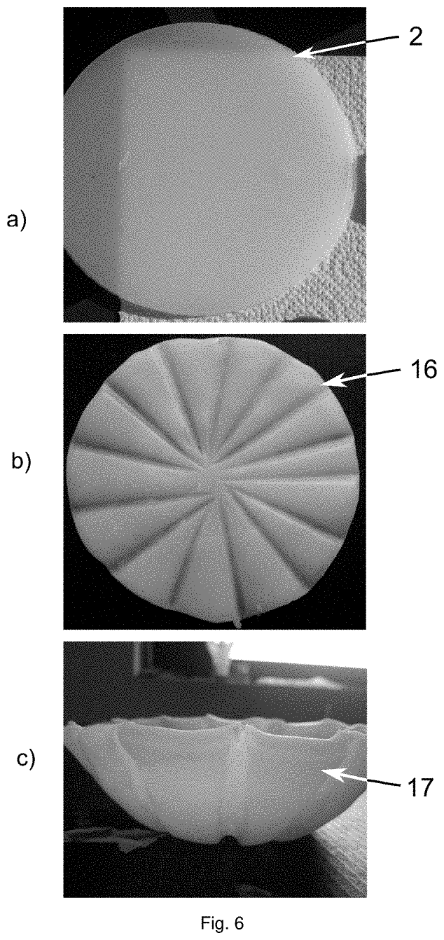

Due to the small thickness, the raw plate (FIG. 2a, FIG. 6a) can be preheated and softened by the heating device (1). The heating device (1) shown in FIG. 3 is a chamber with the heating element (7), the fan (8), the temperature sensor (4), and the timer (5). Also, the heating device has several shelves (3) for placing the raw material blank (2), a candle prepared for transformation or several candles with a wick, or plates of corresponding different geometric shapes prepared for the production of candles. Additionally, the smarter heating devices (1) may have a raw material temperature and condition analyzer capable of measuring or determining the raw material temperature and plasticity status of the blank (2) and indicating that the blank (2) is ready to undergo plastic forming.

The shelves (3) in the chamber of the device (1) can be flat or with special depressions or cavities so that the heated plate (2) takes the desired depression shape, or the warm semi-finished product can be kept in the chamber after its transformation so that it does not harden until the next transformation. Other methods and devices can be used to preheat the plate (2), which can maintain the temperature of the raw material blank at a temperature not higher than the melting point of the raw material. For example, it could be heated water or another liquid. Also, the preheating device (1) can be heated by infrared rays when the air temperature in the chamber of the device does not rise and the higher temperature required for the raw material blank (2) is provided by infrared radiation.

After softening the raw material blank (2) in the preheating device (1) to plasticity, flowers, leaves, feathers and other naturally occurring flat elements or objects consisting of them can be formed or other elements can by sculpted of them by simple kneading, stretching, pressing, twisting, cutting, slashing, or bending movements. Also, if necessary, the partially sculpted candle can be kept in a warm chamber so that it does not solidify until the formation of the candle is completed.

By using the candle as a semi-finished product, after heating it and then bending, stretching, pressing, twisting, and other shaping it creatively in various ways, a new product is obtained from an aesthetic point of view—the shaped candle, the design properties of which are fundamentally different from the previous ones. An essential feature of this production method is that all these shaping operations can be performed safely by hand alone, as the preheated raw material has the plasticity required for sculpting, but at the same time it is not hot enough to burn the hands of the candle-shaping manufacturer.

According to this method, the candle can be formed by hand alone, but, if necessary, it can also be convenient to use plastic sculpting tools, such as:
Insert the wick by making a cavity in the formed candle with a thin tool of solid material (awl, needle);
Cut out an element of the plate with a mold, which at the same time embosses the desired ornament or image, or allows to cut out a blank element of the desired shape with a knife;
To emboss an ornament on the unfinished candle by using simple tools (such as those used in making cookies, e.g. a roller or a punch);
Combine various other suitable tools.

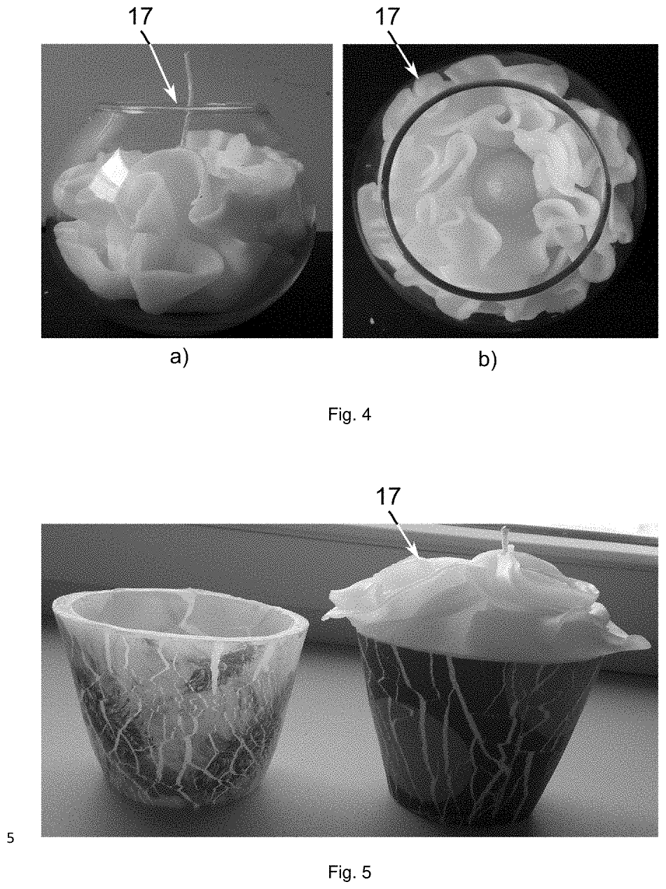

In another embodiment of the invention (FIG. 4), by using this method of candle production, it is possible to place a sculpted and compressed (while warm) object (such as a flower) in a glass (vase) with a small neck (or, for example, a bottle) and then unfold it inside. For example, as shown in FIGS. 4a and 4b. Also, it is possible to place the candle in the glass, the same size as the glass cavity, and then heat it together with the glass so that the candle unfolds and remains cooled and hardened in the glass, no longer pulling out of it.

In another embodiment of the invention (FIG. 5), on the surface of the raw plate, which is the development of another geometric figure, an illustration or ornament may be printed by a printer, or by painting or otherwise forming, and then changing the shape of the plate by hand after preheating this decorated blank in the preheating device (1), to the form of, e.g., a vase, the shape of which may be not only a cylinder or a cone, but also a more complex three-dimensional figure. In the next step of candle production, such vase formed of wax can be used as a semi-finished product into which a folded flower-shaped candle will be incorporated, as shown in FIGS. 5a and 5b.

In another embodiment of the invention (FIG. 6), it is not difficult to emboss the contours, reliefs or embossments of flower blossoms, flowers, tree leaves or other objects on a warm and elastic raw material plate (any shape of the intended three-dimensional figure). Also, it is easy to emboss a raised or concave ornament or illustration, and then change the shape of the plate to the shape of the selected shape. For example, a wax vase with embossed ornaments, as shown in FIGS. 6a, 6b and 6c, is formed in this way.

In another embodiment of the invention, after the drawing is prepared on the raw plate (by hand or printer on a cold plate, embossed or cut on a heated plate), the heated plate is then placed in glass of any shape and pressed against its walls to make the above drawing visible from outside the glass. Alternatively, the preheated raw material (wax) plate with the drawing is tightly wrapped around a standard cylindrical candle. Also, round wax plates can be placed on the top and the bottom. Also, after making a hole in the center of the cylindrical candle blank for the wick and cutting out a wax plate of appropriate size painted with paint or containing a pictogram/logo, place it on the existing standard candles. Known methods of production and decoration (covering the top of the candle with a drawing or a logo symbol) usually use paper, which is removed and discarded before the candle is lit.

In another embodiment, thin raw material plates decorated with embossments or cutouts can be compressed together: one plate is prepared with ornamented cutouts and the other is pressed against the first one and is of a different color to highlight a different color drawing or ornament through the cutouts of the first plate. Such a multilayer-multicolored candle outer shell can be heated and wrapped (as described above) around a standard cylindrical candle, which when lit and translucent will look decorated with its own lighting, colors, and cut-out ornaments.

In another embodiment of the present invention, the manufactured candle in its original shape (e.g., a “Christmas tree” shown in FIG. 2b) may be used not as a final product (for decoration or burning) but as a sample or prototype from which molds or press forms as well as automated molding and painting techniques to produce these uniquely shaped candles in series are subsequently obtained.

The candle production system. The candle production system is designed to produce candles by method as described above. The main components of the candle production system are:
Raw candle blanks (2) from which the candle will be formed. The shapes of the blanks can be varied and unlimited. It is more convenient to sculpt or shape a candle from a raw material blank that is closer in shape to a intended candle. However, in this method of production, candles can be sculpted and formed from raw blanks of any shape (2, 10).
A heating device (1) in which the raw material blank (2) is preheated to a plastic state (11) and can then be re-heated periodically (12) to maintain the plastic state indefinitely, i.e., until the candle is finally formed.
Optionally and additionally, a set of plastic sculpting tools (9) may be used in the system, which includes molding spatulas, knives, picks, cutters, rollers, stamps, gloves, and other tools of similar purpose.

The heating device (1) can be embodied in various ways and use different methods of heating, i.e., heat transfer to the raw material blank (2), for example:
By convection, using a stream of preheated air to heat the blank (2). Such a device can be embodied as a closed or semi-open chamber in which one or more raw blanks, such as plate-shaped blanks, are placed on the shelves of the chamber, as shown in FIG. 3a;
By infrared radiation, where the raw blank of the candle (2) is kept under the lamp emitting infrared radiation for a certain time or throughout the candle-forming period, as shown in FIG. 3b;
By direct contact, for example, when the preheating device (1) is embodied as a heating pad or a flexible mechanically resistant heating mat on a worktable on which the raw material blank (2) is placed and formed, as shown in FIG. 3c.

Also, various combinations of the preheating methods and devices listed above can be used.

The heating device (1) may have means (4, 5) for preheating the blanks (2, 16) and for indicating the state and temperature of the blanks (2, 16), which indicate the blank (2, 16) is ready for shaping. These means (4, 5) can be digital, light, audio, visual, connected to an external smart device (computer, telephone, tablet) and its software, or any combination thereof.

The shape, size, and variety of functions of the system and its components are not fixed and may vary, but it must allow candles to be manufactured as described above, with the raw material blanks being preheated to obtain plasticity and further hand-forming of the candle to obtain the intended final shape.

Candle raw materials. When producing candles by this method, it is important that the raw material that is being formed maintains the plastic state in the hands of the candle maker for a sufficient period of time (the required period of time). From various candle raw materials (stearin, paraffin, candle wax)—some of them can be used to make candles conveniently and safely by this method. The proper temperatures and characteristics of solid/plastic/liquid states of these raw materials are important.

Raw materials that are soft and plastic at temperatures below 30° C. are not practical for making candles because the candle will be soft already at room temperature, so it will not be possible to make larger candles from such raw material. Also, it will not be possible to transport or maintain the decorative shape of the manufactured candle in various other circumstances.

Also, raw materials with a plasticity temperature above 50° C. are unsuitable or less suitable, as such raw materials can no longer be formed comfortably and safely by hand due to high temperatures, thus losing the advantages of this production method. The upper temperature limit is determined by the tolerance of human hands to high temperature, which can be assessed on the basis of data from additional sources (e.g., Barry Michaels et al. “Handwashing Water Temperature Effects on the Reduction of Resident and Transient (Serratia marcescens) Flora when Using Bland Soap” Dairy, Food and Environmental Sanitation, Vol. 21, No. 12, Pages 997-1007), where the test temperature for washing hands is indicated up to 49° C. and the range 43 to 49° C. is defined as the discomfort zone. The effects of higher temperatures on the hands may be mitigated by protective gloves, but additional work safety instructions may also be required.

Thus, the temperature-state characteristic of the raw material is defined by the following four ranges:
The solid state of the raw material is required at room temperature (20-25° C.) and solidification occurs when the raw material is cooled below 30° C.;
Plastic state, when the temperature of the raw material is close to the temperature of the human body (between 30° C. and 40° C.)—it is optimal for forming candles by this method. This state and temperature are the most comfortable and safe to work with the raw material for a long time, without the use of preheating means or using them only occasionally (for example, only before forming the blank).
The plastic state at a temperature higher than the human body temperature (40° C.-50° C.) is acceptable and sufficiently safe, but the raw material and the candle blank will need to be preheated periodically and repeatedly in the heating device (1). Or form a candle in a heated chamber or room where a higher temperature of the raw material is maintained on a regular basis.
The plastic or liquid state, when the temperature of the raw material is significantly above 50° C. (for example, 55° C. and more), when designing or manufacturing candles by this method is useless, because working with hot raw materials is inconvenient and unsafe, making this candle production method.

The simplest raw material suitable for making candles in this way is beeswax, which maintains a solid state at room temperature (20-25° C.), softens to plasticity when its temperature rises to 30-35° C., and reaches a liquid state (“melting point”) at temperature of 60-62° C. When making candles from beeswax, raw material (2) and candle blanks (16), it is recommended to maintain the temperature and plastic state in the range of 35-50° C.

In addition to beeswax, various other raw materials (paraffins, stearins) and raw material compositions with similar state-temperature characteristics suitable for making candles by this method can be used. Therefore, the production method is not limited to specific examples of raw materials and compositions but includes all options for the use of suitable raw materials.

Industrial applicability. The uniquely shaped candle (17) made by the method of present invention can be used not only as a final product (only for decoration or burning), but can also be produced as a sample, model, or prototype of a uniquely shaped candle, from which candle molds or press-forms as well as automated molding and painting techniques adapted to produce candles of that particular unique shape, but in series, will be developed. When manufacturing or modeling a prototype, it is important that its materials and properties are the same as those of future serial candles. Therefore, the methods of casting and pressing and the means for the production of the prototype are too complicated, and the sculpting of the real prototype of the candle from a special soft wax does not provide the candle the right properties.

Another broad application: a publicly available candle production kit for making candles by this method, including production equipment, such as a heating device (1), plastic raw material forming tools (9) (roller, prints, cutters, spatulas, awls), raw material kits and blanks (2), instructions and methodological descriptions of the embodiments. With the help of such a kit, individual developers can produce candles in unique shapes, in which the materials used and the physical (durability, burning) characteristics correspond to or are close to the characteristics of industrial candles. Such a set is fundamentally and qualitatively different from, for example, known on the market “SES Creative Crafts Set for Kids|Easy Candles out of Wax Clay for Kids”.

1. A method of making decorative candles comprising the following steps:
modify the consistency of the candle raw material or candle blank;
forming a candle from a raw material or candle blank with a modified consistency; and
restoring the consistency of the raw material of the formed candle or recovering the raw material of the formed candle to a solid state;
wherein:
during the period of candle formation from the raw material, the production temperature of the candle raw material and at least a part of the produced candle blank is maintained in the range of 30° C. to 50° C. degrees; and
the consistency of the candle raw material and at least a part of the produced candle blank is plastic.

2. The method according to claim 1, wherein the shape of the raw materialand the candle blank is created and changed by hand by means of plastic sculpting.

3. The method according to claim 1, wherein auxiliary tools are used to form the candle, including rollers, stamps, spatulas, knives, cutters, gloves and other plastic sculpture tools.

4. The method according to claim 1, wherein the candle raw material is beeswax, palm wax, paraffin, stearin, mixtures thereof, and other raw materials suitable for the production of candles, which can have or acquire a plastic consistency in the production temperature range.

5. The method according to claim 1, wherein the plastic consistency of the raw material and the candle blank is achieved and maintained by preheating means or by preheating the raw material in hot water.

6. Method according to claim 1, wherein the plastic consistency of the raw material and/or the candle blank is maintained by periodically repeating the preheating of the blanks throughout the candle formation period, thus preventing raw material of the blanks from loosing its plastic consistency.

7. The method according to claim 1, wherein the plastic consistency of the raw material and the candle blanks is maintained by heat of the hand up to a temperature of 37° C.

8. The method according to claim 1, wherein the plastic consistency of the raw material and the candle blanks is maintained in the production temperature range from 30° C. to 50° C. throughout the candle formation period by continuously heating the blanks with the heating device.

9. The method according to claim 1, wherein the surface of the formed candle can be further decorated by painting it with paint.

10. The method according to claim 1, wherein the color gamut of the candle is created by using raw material blanks with different colors.

11. A decorative candle production system for producing candles according to claim 1, wherein the system comprises the following elements:
one or more raw blanks and one or more candle blanks from which the candle is formed;
one or more wicks, wherein the wick may be provided in the raw material blank or provided separately from the raw material blank; and
a heating device for raw materials and candle blanks;
wherein:
the one or more raw material blanks and at least a part of the one or more candle blanks in the system reach and maintain a plastic consistency, in which case the shape of the one or more raw material blanks and / or the one or more candle blanks is changed by hand by means of plastic sculpturing.

12. The system according to claim 11, wherein the heating device has means for heating the blanks and for indicating the state and temperature of the blanks, which indicate that the blanks are ready for shaping.

13. The system according to claim 9, wherein the means for indicating the state and temperature of the raw material and the candle blanks can be digital, light, audio, visual, connected to an external smart device (computer, telephone, tablet) and its software, or any combination thereof.

14. The system according to claim 9, wherein the raw material heating device heats the raw material blank in at least one of the following ways: convection by air-blowing the blank with heated air, heating by infrared radiation or heating by direct contact of the blanks with the heating device, such as a heating pad or a heating desktop cover, on which the raw material blank is placed.

15. Candle raw material for the production of decorative candles, wherein the raw material has a material composition that allows it to maintain a plastic consistency with the help of heat of the hands in the temperature range of 30-37° C.
